(19) United States
(12) Patent Application Publication
(10) Pub. No.: US 2002/0193503 A1
(43) Pub. Date: Dec. 19, 2002

(54) FIPG fluoroelastomer compositions

(76) Inventors: Mikio Shiono, Gunma-ken (JP); Makoto Saitoo, Gunma-ken (JP)

Correspondence Address: BIRCH STEWART KOLASCH & BIRCH, PO BOX 747, FALLS CHURCH, VA, 22040-0747, US

(21) Appl. No.: 10/135,388

(22) Filed: May 1, 2002

(30) Foreign Application Priority Data
May 11, 2001 (JP) 2001-142111

(51) Int. Cl. C08J 3/00

(52) U.S. Cl. 524/588

(57) ABSTRACT

A fluoroelastomer composition is suited for FIPG comprising (A) a fluorinated amide compound having at least two alkenyl radicals, (B) a fluorinated organohydrogen-siloxane having at least two SiH radicals, (C) a platinum group catalyst, and (D) a hydrophobic silica powder. The composition cures into an elastomer or FIPG having good heat resistance, oil resistance, chemical resistance, solvent resistance, low-temperature properties, and moisture resistance, and especially superior oil resistance and chemical resistance, increasing the lifetime and reliability of seal performance.

This invention relates to fluoroelastomer compositions giving cured parts having improved heat resistance, oil resistance, chemical resistance, solvent resistance, low-temperature properties and moisture resistance and suited for formed-in-place gaskets (FIPG).

### BACKGROUND OF THE INVENTION

In the prior art process of assembling automobile engines and related mechanical components such as oil pans and transmissions, silicone sealing materials known as liquid gaskets are used around flanges for preventing gas and oil leakage therethrough. The liquid gasket material is applied in bead form to one of mating surfaces to be sealed, using an applicator robot. Before or after curing, the bead is pressed between mating surfaces to form a gasket in place. The gasket sealing system based on a combination of the silicone liquid gasket material with the applicator robot is known as formed-in-place gasket (FIPG). FIPG is utilized in many industrial fields as well as the automotive industry since it contributes to energy saving, resource saving, reduction of part size and weight, and reduction of process steps.

FIPG materials are required to be heat resistant. They are also required to be oil resistant, namely resistant to engine oil, gear oil, transmission oil or LLC, depending on the area where they are used. Liquid silicone rubbers capable of satisfying these requirements have been marketed. Since various additives are currently added to oil in high concentrations for reducing the viscosity and extending the life of oil, it is desired that the FIPG materials be further improved in oil and chemical resistance.

Liquid silicone rubbers have good heat resistance, but their oil and chemical resistance is insufficient in the FIPG application. Improvements in these properties are desired. However, due to limitations ascribable to the molecular structure of the base polymer, it is difficult to improve the oil and chemical resistance of liquid silicone rubbers. It would be desirable to have a liquid rubber composition for FIPG having superior oil resistance and chemical resistance to liquid silicone rubber compositions.

### SUMMARY OF THE INVENTION

An object of the invention is to provide a novel and improved fluoroelastomer composition for FIPG which cures into an elastomer that has good heat resistance, oil resistance, chemical resistance, solvent resistance, low-temperature properties, and moisture resistance.

It has been found that the above problems can be overcome by a composition comprising (A) a fluorinated amide compound having at least two alkenyl radicals in a molecule, (B) a fluorinated organohydrogensiloxane as a crosslinking and chain extending agent, (C) a platinum group compound as a curing catalyst, (D) a hydrophobic silica powder as a reinforcing and thixotropic filler, and optionally (E) an organosiloxane having in a molecule a hydrogen atom attached to a silicon atom, and an epoxy radical attached to a silicon atom through carbon atoms or carbon and oxygen atoms or a trialkoxy radical or both as a tackifier.

Specifically, the invention provides a fluoroelastomer composition for FIPG comprising as essential components, (A) a fluorinated amide compound having at least two alkenyl radicals in a molecule, (B) a fluorinated organohydrogen-siloxane having at least two hydrogen atoms attached to silicon atoms in a molecule, (C) a catalytic amount of a platinum group compound, (D) a hydrophobic silica powder. The composition may further comprise (E) an organosiloxane having in a molecule at least one hydrogen atom attached to a silicon atom, and at least one epoxy radical attached to a silicon atom through carbon atoms or carbon and oxygen atoms or at least one trialkoxy radical or both.

### DESCRIPTION OF THE PREFERRED EMBODIMENT

Briefly stated, the fluoroelastomer composition for FIPG of the invention contains (A) a fluorinated amide compound having at least two alkenyl radicals in a molecule as a base polymer, (B) a fluorinated organohydrogensiloxane as a crosslinking and chain extending agent, (C) a platinum group compound as a curing catalyst, and (D) a hydrophobic silica powder as a reinforcing and thixotropic filler.

Component (A) is a fluorinated amide compound which should have at least two alkenyl radicals in a molecule, and preferably at least one alkenyl radical at each of opposite ends. In the compound, fluorine is preferably contained as a monovalent perfluorooxyalkyl, monovalent perfluoroalkyl, divalent perfluorooxyalkylene or divalent perfluoroalkylene radical. Preferably the compound has the following linkage.

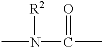

Herein R² is hydrogen or a substituted or unsubstituted monovalent hydrocarbon radical having 1 to 10 carbon atoms, especially 1 to 8 carbon atoms, and preferably free of aliphatic unsaturation.

Further, the compound may have the following linkage.

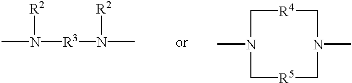

Herein R² is as defined above; R³ is a substituted or unsubstituted divalent hydrocarbon radical which may be separated by at least one atom of oxygen, nitrogen and silicon atoms; R⁴ and R⁵ each are a substituted or unsubstituted divalent hydrocarbon radical.

The fluorinated amide compound (A) is preferably of the following general formula (1).

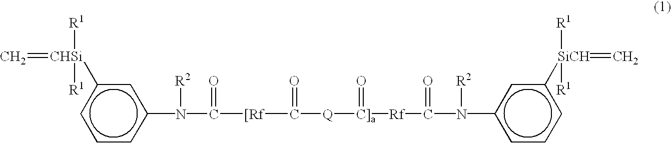

Referring to formula (1), R¹ stands for substituted or unsubstituted monovalent hydrocarbon radicals preferably of 1 to 10 carbon atoms, more preferably 1 to 8 carbon atoms, and also preferably free of aliphatic unsaturation. Examples include alkyl radicals such as methyl, ethyl, propyl, isopropyl, butyl, isobutyl, tert-butyl, pentyl, hexyl, octyl and decyl; cycloalkyl radicals such as cyclopentyl, cyclohexyl and cycloheptyl; alkenyl radicals such as vinyl, allyl, propenyl, isopropenyl, butenyl, and hexenyl; aryl radicals such as phenyl, tolyl, xylyl and naphthyl; aralkyl radicals such as benzyl, phenylethyl and phenylpropyl; and substituted ones of these radicals in which some or all of the hydrogen atoms are replaced by halogen atoms or the like, typically fluorinated alkyl radicals such as chloromethyl, chloropropyl, bromoethyl, 3,3,3-trifluoropropyl, and 6,6,6,5,5,4,4,3,3-nonafluorohexyl.

R² stands for hydrogen or substituted or unsubstituted monovalent hydrocarbon radicals preferably of 1 to 10 carbon atoms, more preferably 1 to 8 carbon atoms, and also preferably free of aliphatic unsaturation, as defined above for R¹. Examples of the monovalent hydrocarbon radicals are as exemplified above for R¹, for example, alkyl radicals such as methyl, ethyl, propyl, and isopropyl; cycloalkyl radicals such as cyclohexyl; alkenyl radicals such as vinyl and allyl; aryl radicals such as phenyl and tolyl; and substituted ones of these radicals in which some hydrogen atoms are replaced by halogen atoms or the like, typically fluorinated alkyl radicals such as chloromethyl, chloropropyl, 3,3,3-trifluoropropyl, and 6,6,6,5,5,4,4,3,3-nonafluorohexyl.

Q is a radical of the following general formula (2) or (3).

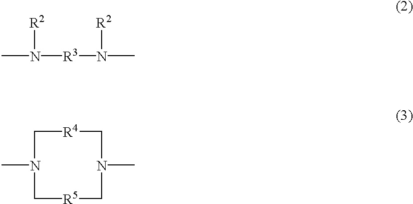

R² in formula (2) is as defined above. R³ may be selected from substituted or unsubstituted divalent hydrocarbon radicals, preferably from divalent hydrocarbon radical of 1 to 20 carbon atoms, especially 2 to 10 carbon atoms. Examples include alkylene radicals such as methylene, ethylene, propylene, methylethylene, butylene and hexamethylene; cycloalkylene radicals such as cyclohexylene; arylene radicals such as phenylene, tolylene, xylylene, naphthylene and biphenylene; substituted ones of these radicals in which some hydrogen atoms are replaced by halogen atoms or the like; and combinations of these substituted or unsubstituted alkylene and arylene radicals.

R³ may contain one or more atoms of oxygen, nitrogen and silicon atoms at an intermediate of its linkage. In this case, the oxygen atom intervenes in the linkage of R³ in the form of —O—. The nitrogen atom intervenes in the linkage of R³ in the form of —NR′— wherein R′ is hydrogen, alkyl of 1 to 8 carbon atoms, especially 1 to 6 carbon atoms or aryl. The silicon atom intervenes in the linkage of R³ in the form of a straight or cyclic organosiloxane-containing radical or organosilylene radical as shown below.

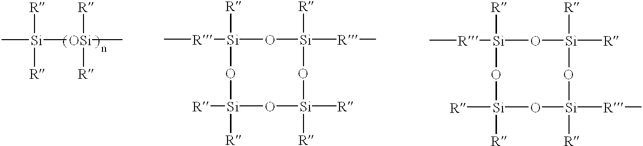

Herein, R″ is an alkyl radical of 1 to 8 carbon atoms or aryl radical as exemplified for R¹ and R², R″′ is an alkylene radical of 1 to 6 carbon atoms or arylene radical as exemplified for R³, and n is an integer of 0 to 10, especially 0 to 5.

Examples of these radicals are given below.

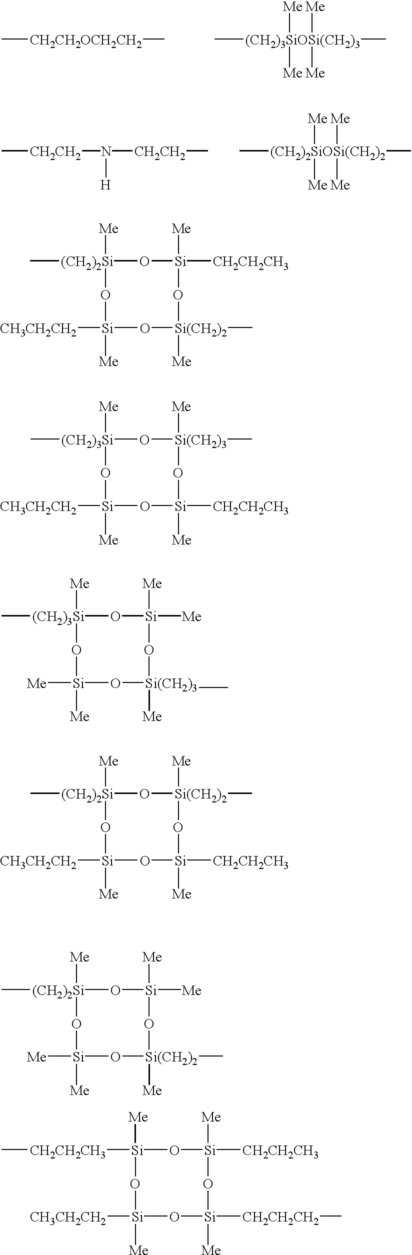

In the above formulae, Me is methyl.

In formula (3), R⁴ and R⁵ are substituted or unsubstituted divalent hydrocarbon radicals of 1 to 10 carbon atoms, especially 2 to 6 carbon atoms. Illustrative are alkylene radicals such as methylene, ethylene, propylene, methylethylene, butylene, and hexamethylene, cycloalkylene radicals such as cyclohexylene, and substituted ones of these radicals in which some of the hydrogen atoms are replaced by halogen atoms.

The radicals Q in formula (1), represented by formula (2) or (3), are exemplified below. In the following chemical formulae, Me is methyl, Ph is phenyl, and X is hydrogen, methyl or phenyl.

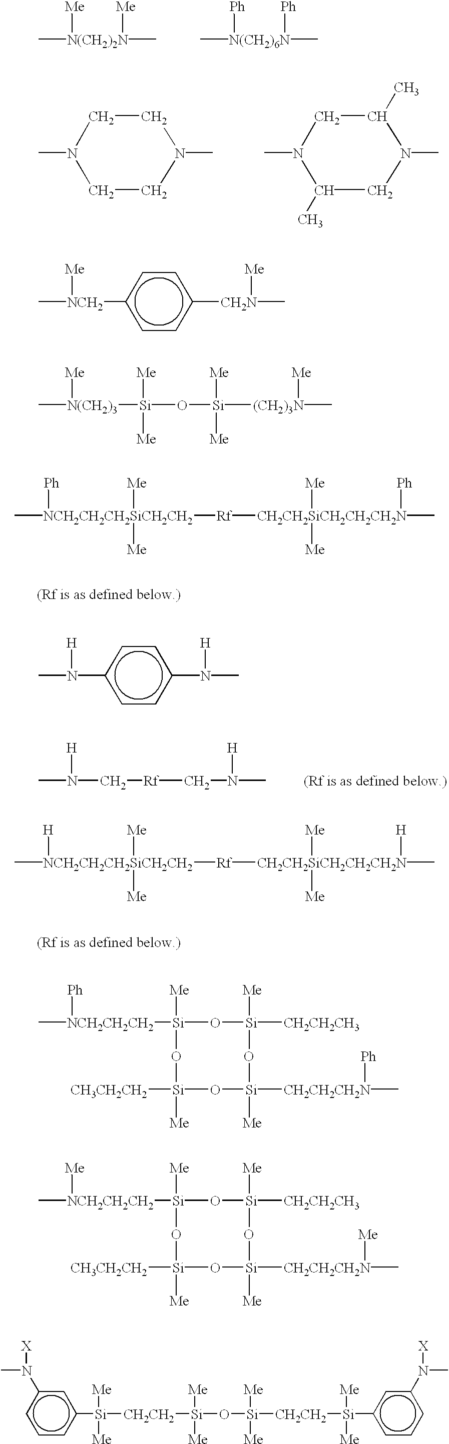

In formula (1), Rf is a divalent perfluoroalkylene radical or divalent perfluoropolyether radical. The preferred divalent perfluoroalkylene radical is represented by —CₘF₂ₘ— wherein m is 1 to 10, preferably 2 to 6. The preferred divalent perfluoropolyether radical is represented by the following formulae:

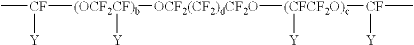

wherein Y is F or CF₃ radical, b, c and d are integers satisfying b≧1, c≧1, 2≦b+c≦200, especially 2≦b+c≦110, and 0≦d≦6;

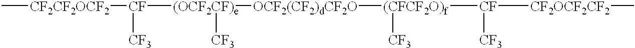

wherein d, e and f are integers satisfying 0≦d≦6, e≦0, f≦0, and 0≦e+f≦200, especially 2≦e+f≦110;

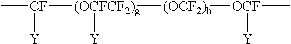

wherein Y is F or CF₃ radical, g and h are integers satisfying 1≦g≦20 and 1≦h≦20;

—CF₂CF₂—(OCF₂CF₂CF₂)ᵢ—OCF₂CF₂—

wherein i is an integer of 1 to 100.

Illustrative examples of Rf are given below.

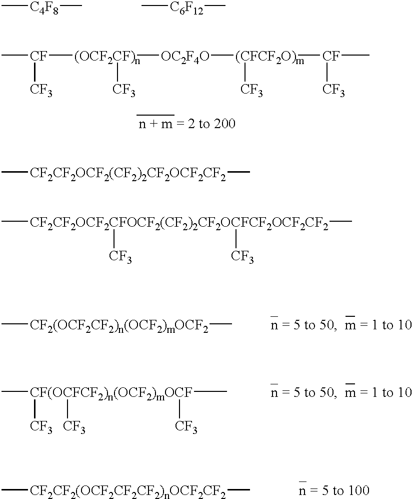

In formula (1), letter “a” is an integer inclusive of 0, which indicates that the fluorinated amide compound of formula (1) contains at least one divalent perfluoroalkylene radical or divalent perfluoropolyether radical in a molecule. Preferably, “a” is an integer of 0 to 10, and more preferably 1 to 6.

The fluorinated amide compound (A) used herein may range from a low viscosity polymer having a viscosity of about several tens of centistokes at 25° C. to a solid gum-like polymer. From the standpoint of ease of handling, a gum-like polymer is suited for use as heat vulcanizable rubber, and a polymer having a viscosity of about 100 to 100,000 centistokes at 25° C. is suited for use as liquid rubber. With too low a viscosity, the resulting cured elastomer may be short in elongation and fail to provide a good profile of physical properties.

The fluorinated amide compound of formula (1) can be prepared by the following method. For example, a fluorinated amide compound of formula (1) wherein “a” =0 can be synthesized, for example, by reacting a compound having acid fluoride radicals at both ends represented by the general formula (4) with a primary or secondary amine compound represented by the general formula (5) in the presence of an acid acceptor such as trimethylamine.

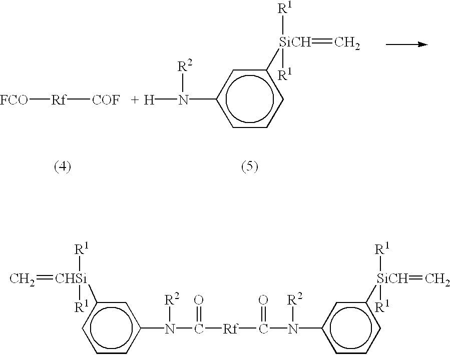

Herein, R¹, R² and Rf are as defined above.

Further, a fluorinated amide compound of formula (1) wherein “a” is an integer of at least 1 can be synthesized, for example, by reacting a compound having acid fluoride radicals at both ends represented by formula (4) with a diamine compound represented by the general formula (6):

H—Q—H (6)

wherein Q is as defined above, in the presence of an acid acceptor, followed by reaction with a primary or secondary amine compound of formula (5).

In the former procedure, the relative amounts of the compound having acid fluoride radicals at both ends of formula (4) and the primary or secondary amine compound of formula (5) charged are not critical. Preferably the amount (a) of the compound of formula (4) and the amount (b) of the compound of formula (5) charged are adjusted such that the molar ratio of (a)/(b) may range from 0.1/1 to 1.2/1 mol/mol, and especially from 0.2/1 to 0.5/1 mol/mol.

In the latter procedure, the amount (a) of the compound of formula (4) and the amount (c) of the compound of formula (6) charged are not critical as long as the molar amount (a) is not smaller than the molar amount (c). The recurring units (a) in formula (1) may be set to an appropriate value for a particular purpose by adjusting the molar ratio of (a)/(c). With greater settings of (a)/(c), polymers having a relatively low molecular weight can be synthesized. With setting of (a)/(c) approximate to unity (1), polymers having a relatively high molecular weight can be synthesized.

Reaction conditions are not critical although the preferred conditions include 20 to 100° C. and 1 to 8 hours, and more preferably 20 to 50° C. and 2 to 4 hours.

It is noted that the fluorinated amide compound of formula (1) wherein Q is a linkage having an intervening silicon atom can be synthesized, for example, by first effecting reaction as mentioned above using an amine compound of formula (5) as the primary or secondary amine compound having an aliphatic unsaturated radical such as vinyl or allyl, thereby forming a both end vinyl-terminated compound of the following general formula (7), then reacting the compound of formula (7) with an organosiloxane compound having two hydrosilyl radicals in a molecule, as represented by the following general formula (8), in the presence of an addition reaction catalyst.

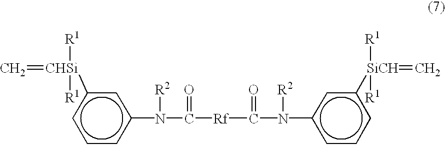

Herein R¹, R² and Rf are as defined above.

H—P—H (8)

Herein P is a divalent organic radical having a siloxane linkage, illustrative examples of which are given below.

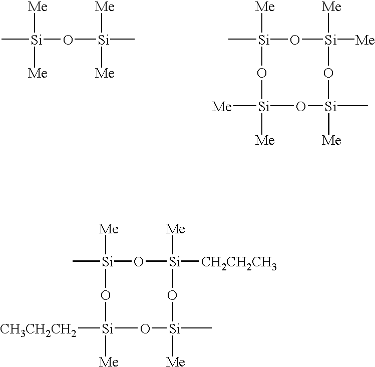

In this reaction, the relative amounts of the both end vinyl-terminated compound of formula (7) and the compound of formula (8) charged should be such that the molar amount (d) of the compound (7) charged be greater than the molar amount (e) of the compound (8) charged. The ratio of (d)/(e) is at most 2. That is, 1<(d)/(e)≦2. With greater settings of (d)/(e), polymers having a relatively low molecular weight can be synthesized. With setting of (d)/(e) approximate to unity (1), polymers having a relatively high molecular weight can be synthesized.

The catalyst used herein may be selected from elements of Group VIII in the Periodic Table and compounds thereof, for example, chloroplatinic acid, alcohol-modified chloroplatinic acid (see U.S. Pat. No. 3,220,972), complexes of chloroplatinic acid with olefins (see U.S. Pat. Nos. 3,159,601, 3,159,662 and 3,775,452), platinum black and palladium on such carriers as alumina, silica and carbon, rhodium-olefin complexes, and chlorotris(triphenylphosphine)rhodium (known as Wilkinson catalyst). Such a catalyst may be used in a catalytic amount. The above-described complexes are preferably used as solutions in alcohol, ketone, ether and hydrocarbon solvents.

The preferred reaction conditions include 50 to 150° C., more preferably 80 to 120° C. and 2 to 4 hours.

Component (B) is a fluorinated organohydrogensiloxane having at least two hydrogen atoms attached to silicon atoms in a molecule. It serves as a crosslinker and chain extender for the fluorinated amide compound (A). The fluorinated organohydrogensiloxane should preferably have at least one monovalent perfluorooxyalkyl, monovalent perfluoroalkyl, divalent perfluorooxyalkylene or divalent perfluoroalkylene radical, and at least two, more preferably at least three hydrosilyl radicals (i.e., SiH radicals) in a molecule.

The perfluorooxyalkyl, perfluoroalkyl, perfluorooxy-alkylene and perfluoroalkylene radicals are typically represented by the following general formulae.

Monovalent perfluoroalkyl radical:

—CₘF₂ₘ— wherein m is an integer of 1 to 20, and preferably 2 to 10.

Divalent perfluoroalkylene radical:

—CₘF₂ₘ— wherein m is an integer of 1 to 20, and preferably 2 to 10.

Monovalent perfluorooxyalkyl radical:

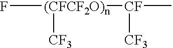

wherein n is an integer of 1 to 5.

Divalent perfluorooxyalkylene radical:

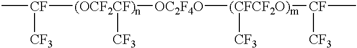

wherein an average of m+n is an integer of 2 to 100.

The fluorinated organohydrogensiloxane may be cyclic or chain-like or even three-dimensional network. Especially preferred are fluorinated organohydrogensiloxanes having in the molecule at least one monovalent organic radical containing a perfluoroalkyl, perfluoroalkyl ether or perfluoroalkylene, as shown below, as a monovalent substituent attached to a silicon atom.

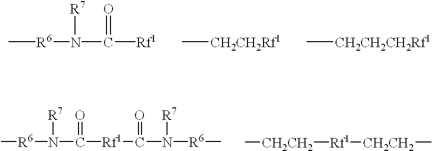

In the above formulae, R⁶ stands for divalent hydrocarbon radicals of 1 to 10 carbon atoms, and especially 2 to 6 carbon atoms, for example, alkylene radicals such as methylene, ethylene, propylene, methylethylene, tetramethylene and hexamethylene, and arylene radicals such as phenylene. R⁷ stands for hydrogen or monovalent hydrocarbon radicals, preferably of 1 to 8 carbon atoms, and especially 1 to 6 carbon atoms as described for R². Rf¹ stands for monovalent perfluoroalkyl, monovalent perfluoro-oxyalkyl, divalent perfluorooxyalkylene or divalent perfluoroalkylene radicals as described above.

In addition to the monovalent organic radical containing a mono or di-valent fluorinated substituent, i.e., a perfluoroalkyl, perfluorooxyalkyl, perfluorooxy-alkylene or perfluoroalkylene radical, the fluorinated organohydrogensiloxane (B) has a monovalent substituent attached to a silicon atom, which is typically selected from aliphatic unsaturation-free monovalent hydrocarbon radicals of 1 to 10 carbon atoms, and especially 1 to 8 carbon atoms, as described for R².

In the fluorinated organohydrogensiloxane, the number of silicon atoms in a molecule is usually about 2 to 60, preferably about 4 to 30 though not limited thereto.

Examples of the fluorinated organohydrogensiloxane are given below. They may be used alone or in admixture of two or more. Note that Me is methyl and Ph is phenyl.

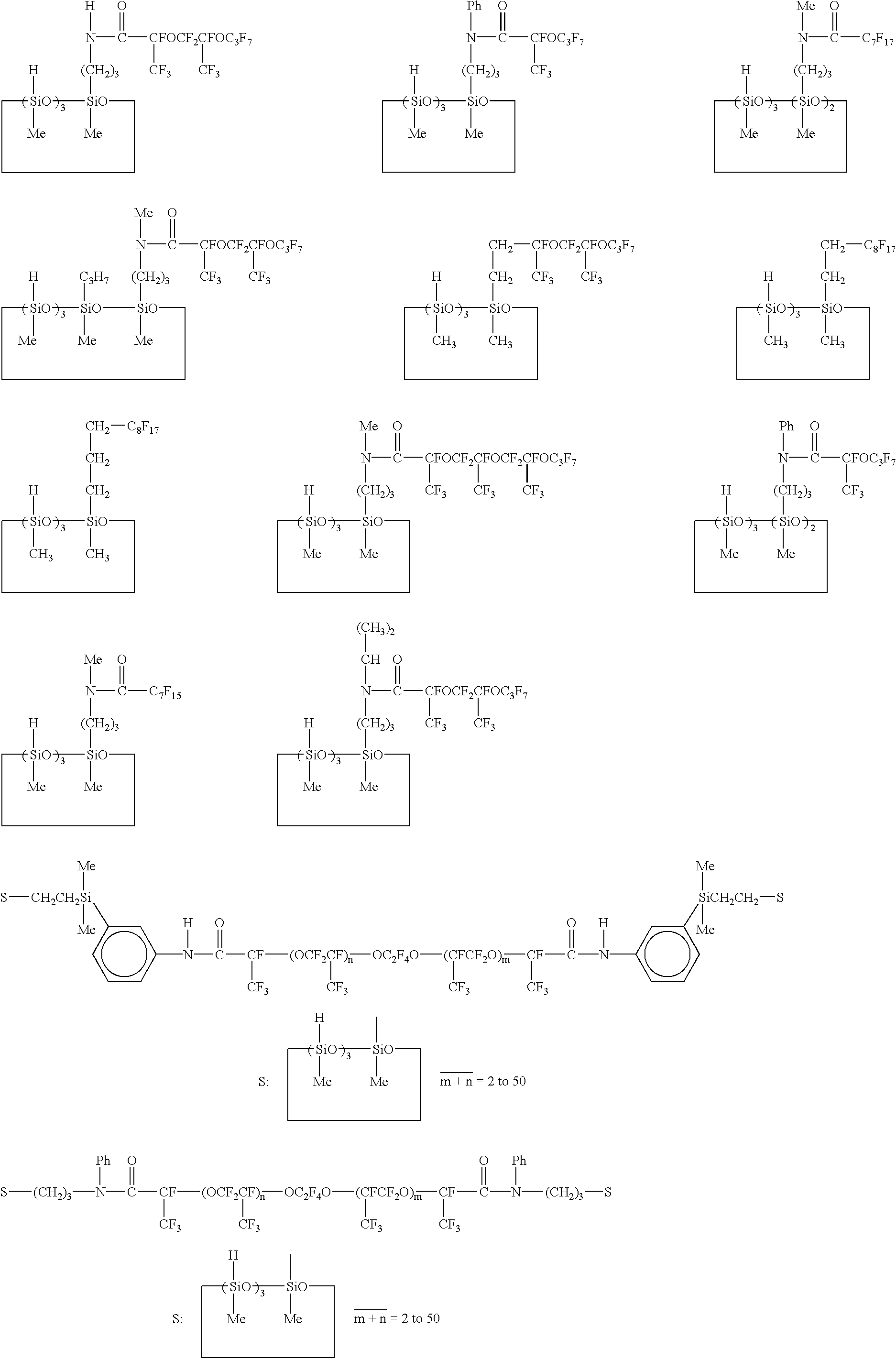

If the fluorinated organohydrogensiloxane (B) used is compatible with the fluorinated amide compound (A), then the curable composition will cure into a uniform product.

Component (B) is preferably used in such amounts that 0.5 to 5 mol, more preferably 1 to 2 mol of hydrosilyl radicals (i.e., SiH radicals) are available per mol of aliphatic unsaturated radicals (including vinyl, allyl and cycloalkenyl radicals) in the entire composition. Amounts of component (B) giving less than 0.5 mol of SiH radicals may achieve an insufficient degree of crosslinking. With excessive amounts of component (B) giving more than 5 mol of SiH radicals, chain extension may become preferential, resulting in undercure, foaming, heat resistance decline and/or compression set decline. More illustratively, about 0.1 to 50 parts by weight of component (B) is preferably blended with 100 parts by weight of component (A).

Component (C) of the inventive composition is a platinum group compound for promoting addition reaction or hydrosilylation between the fluorinated amide compound (A) and the fluorinated organohydrogensiloxane (B), that is, a curing promoter. These compounds are generally noble metal compounds which are expensive, and therefore, platinum compounds which are relatively easily available are often employed.

The platinum compounds include, for example, chloroplatinic acid, complexes of chloroplatinic acid with olefins such as ethylene, complexes of chloroplatinic acid with alcohols and vinylsiloxanes, and platinum on silica, alumina or carbon, though are not limited thereto. Known examples of the platinum group compounds other than the platinum compound are rhodium, ruthenium, iridium and palladium compounds, for example, RhCl(PPh₃)₃, RhCl(CO)(PPh₃)₂, RhCl(C₂H₄)₂, Ru₃(CO)₁₂, IrCl(CO)(PPh₃)₂, and Pd(PPh₃)₄.

The catalyst may be used as such if it is a solid catalyst. However, to obtain a more uniform cured product, it is recommended that a solution of chloroplatinic acid or a complex thereof in a suitable solvent be admixed with the fluorinated amide compound (A) in a miscible manner.

The amount of the catalyst used is not critical and a catalytic amount may provide a desired cure rate. From the economical standpoint and to obtain a satisfactory cured product, the preferred amount of the catalyst is about 1 to 1,000 ppm, more preferably about 5 to 500 ppm of platinum group metal based on the weight of the entire composition.

Component (D) is a hydrophobic silica powder, which serves to impart adequate physical strength to the cured composition and endow the composition with an adequate ability to maintain its shape immediately after extrusion coating from a dispenser. The hydrophobic silica powder (D) is typically obtained by hydrophobizing any well-known particulate silica having a BET specific surface area of at least 50 m²/g. Exemplary of the particulate silica are fumed silica, precipitated silica and colloidal silica, with the fumed silica being most preferred. The particulate silica should preferably have a BET specific surface area of at least 50 m²/g, and especially 100 to 400 m²/g. The agents for hydrophobizing silica particulates include organochloro-silanes, organodisilazanes, cyclic organopolysilazanes, linear organopolysiloxanes, cyclic organopolysiloxanes, etc. Of these, organodisilazanes and cyclic organopolysilazanes are preferred. Preferably the hydrophobic silica powder has been treated prior to its addition to the composition.

An appropriate amount of component (D) added is 3 to 30 parts, and preferably 5 to 25 parts by weight per 100 parts by weight of component (A). Less than 3 parts of component (D) may fail to give cured products sufficient physical properties. More than 30 parts of component (D) may obstruct the extrusion of the composition through the dispenser and adversely affect the physical strength and compression set of cured products.

Various additives may be added to the FIPG composition of the invention to improve its practical usage. In particular, the preferred composition contains as a tackifier (E) an organosiloxane having in a molecule at least one hydrogen atom attached to a silicon atom, and at least one epoxy radical attached to a silicon atom through carbon atoms or carbon and oxygen atoms and/or at least one trialkoxy radical. Examples are organosiloxanes of the structural formulae shown below. They may be used alone or in admixture of any.

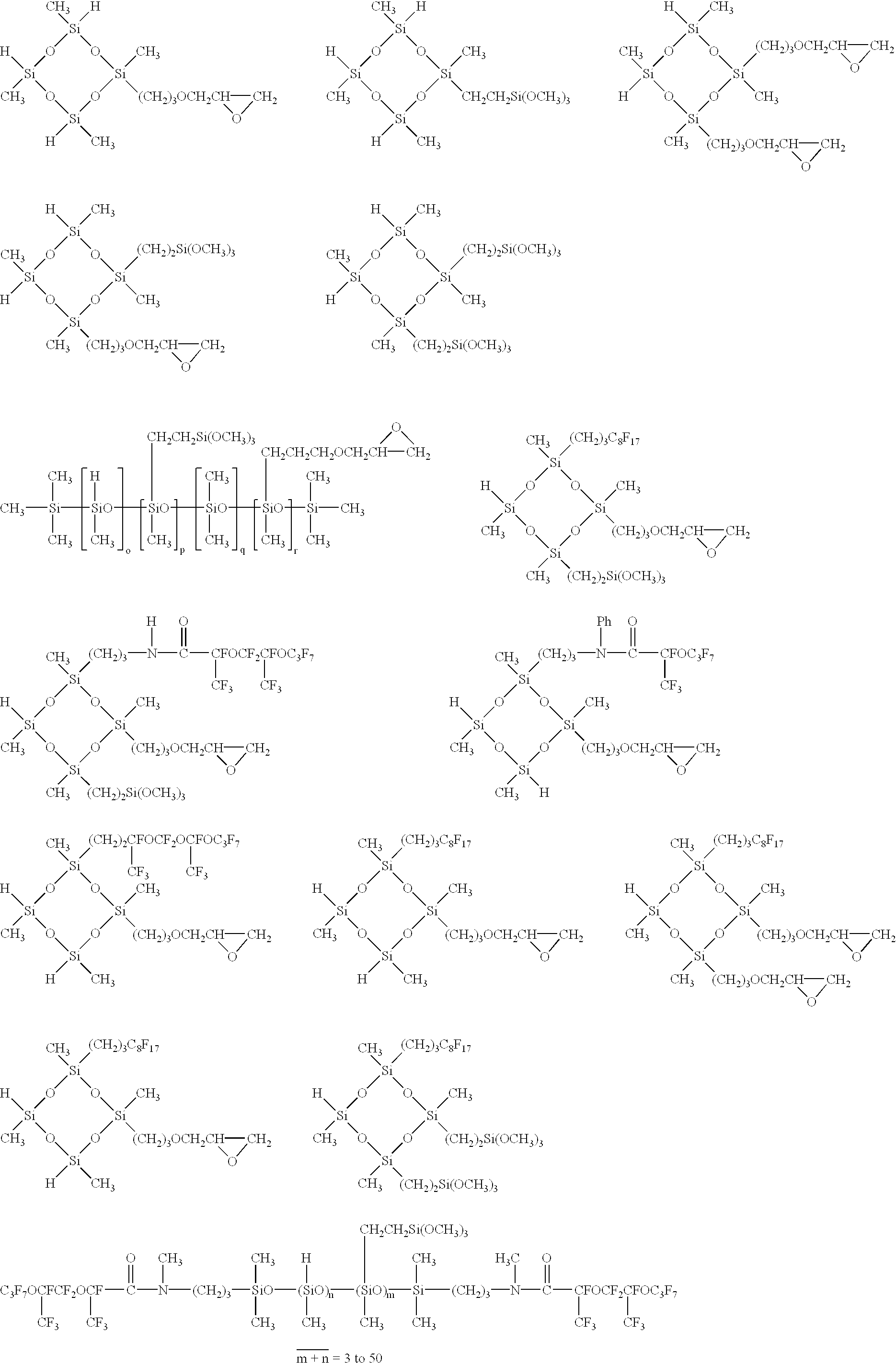

(Herein, o, q and r are positive integers and p is an integer inclusive of 0.)

An appropriate amount of component (E) used is about 0.1 to 10 parts, more preferably about 0.2 to 5 parts by weight per 100 parts by weight of component (A). Less than 0.1 part of component (E) may fail to improve adhesion. More than 10 parts of component (E) may impede the flow of the composition and hence, extrusion from the dispenser and adversely affect the physical properties and compression set of cured products.

It is understood that the amount of component (B) blended is determined by taking into account the amounts of fluorinated amide compound (A), organosiloxane (E) and an optional fluorinated amide compound of the general formula (9) to be described later and such that 0.5 to 5 mol of SiH radicals are available per mol of aliphatic unsaturated radicals (including vinyl, allyl and cycloalkenyl radicals) in the entire composition, as previously described.

When component (E) is contained in the inventive composition, a carboxylic acid anhydride may be simultaneously added. Examples of suitable additives that may be optionally added to the inventive composition include reaction controlling agents, for example, acetylene compounds (e.g., acetylenic alcohols and silylated acetylenic alcohols), olefinic siloxanes and ethylenically unsaturated isocyanurates, and preferably acetylene compounds having the aforementioned monovalent fluorinated substituent radicals in a molecule, olefinic siloxanes and ethylenically unsaturated isocyanurates; semi-reinforcing fillers such as quartz flour, fused quartz powder, diatomaceous earth and calcium carbonate; inorganic pigments such as titanium oxide, iron oxide, carbon black, and cobalt aluminate; heat resistance modifiers such as titanium oxide, iron oxide, carbon black, cerium oxide, cerium hydroxide, zinc carbonate, magnesium carbonate, and manganese carbonate; heat conductive agents such as alumina, boron nitride, silicon carbide and powdered metals; and electroconductive agents such as carbon black, powdered silver and conductive zinc white. In addition, non-functional perfluoropolyethers and/or fluorinated amide compounds of general formula (9) below may be added as viscosity modifiers and flexibility-imparting agents.

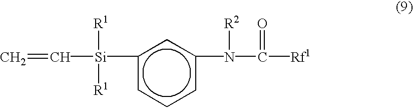

In formula (9), R¹, R² and Rf¹ are as defined above.

The above additives may be added in any suitable amount, insofar as the objects of the invention are attainable.

The FIPG composition of the invention may be prepared by intimately mixing components (A) to (D) and optional components in a suitable mixer such as a planetary mixer, Ross mixer or Hovert mixer, and optionally a milling mixer such as a three-roll mill or kneader. The inventive composition becomes room temperature curable if the functional radicals on the fluorinated amide compound (A) and the catalyst (C) are properly selected. However, it is recommended to heat the composition in order to promote cure. In order to acquire satisfactory compression set property, the composition is preferably cured by heating at a temperature of 60° C. or higher, especially 100 to 200° C. for 10 minutes to 24 hours.

The fluoroelastomer compositions for FIPG according to the invention cure into elastomers that have good heat resistance, oil resistance, chemical resistance, solvent resistance, low-temperature properties, and moisture resistance. In particular, their oil resistance and chemical resistance are markedly superior to those of prior art liquid silicone rubber compositions. This increases the lifetime and reliability of seal performance. The compositions enable FIPG materials to find a new application, for example, replacement of preformed fluororubber gaskets by FIPG.

### EXAMPLE

Examples of the invention are given below by way of illustration and not by way of limitation. All parts are by weight, viscosity is a measurement at 25° C., and Me is methyl.

### Example 1

A planetary mixer was charged with 100 parts of a polymer of formula (10) below (viscosity 10,000 mPa·s, number average molecular weight 17,000, vinyl content 0.012 mol/100 g), to which 10 parts of fumed silica (BET specific surface area 190 m²/g) which had been surface treated with hexamethylcyclotrisilazane was added. The contents were kneaded for one hour without heating. With kneading continued, the mixer was heated until the internal temperature reached 150° C. While a temperature of 150 to 170° C. was kept, the contents were heat treated for 2 hours under vacuum (60 Torr). The contents were then cooled to below 40° C. and passed two times through a three-roll mill, obtaining a base compound.

A planetary mixer was charged with 110 parts of the base compound, to which were successively added 0.40 part of a toluene solution of platinum-divinyltetramethyldisiloxane complex (platinum concentration 0.5 wt %), 0.30 part of a 50% toluene solution of ethynylcyclohexanol, and 1.9 parts of fluorinated organohydrogensiloxane of formula (11) below. The ingredients were mixed until uniform and thereafter, degassed, yielding the final composition.

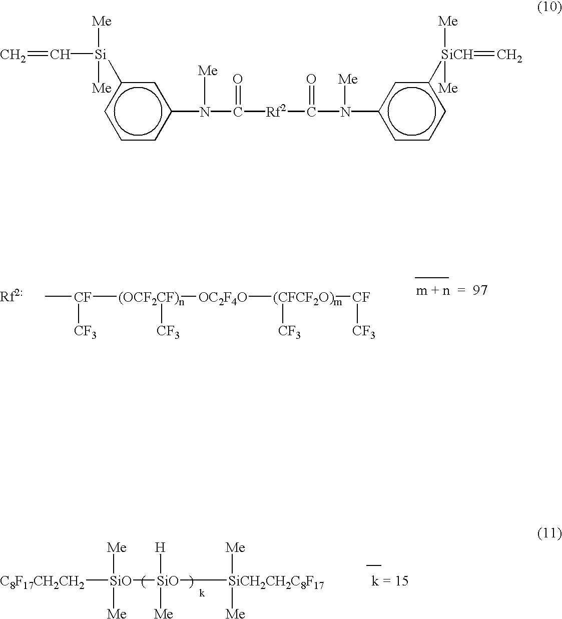

In the above formulae, Me is methyl.

Next, a syringe was filled with the composition. From a nozzle having an inner diameter of 1.2 mm, the composition was extruded onto a polycarbonate resin plate (100×25×2 mm) in bead form. The bead was allowed to stand for one hour, before it was cured by heating in a dryer at 130° C. for one hour. The cured bead had a height (H) and a width (W) in a ratio H/W of 0.90. Separately, the composition was placed in a rectangular mold of 2 mm deep, press cured at 100 kg/cm² and 150° C. for 10 minutes, and oven cured at 150° C. for 50 minutes, obtaining a cured sheet. Using a dumbbell die, a No. 2 dumbbell specimen was punched out of the sheet. Physical properties of the specimen were measured according to JIS K6249, with the results shown in Table 1. Additional No. 2 dumbbell specimens were subjected to an oil resistance test and a chemical resistance test.

Oil resistance: transmission oil resistance (change of physical properties after 1000 hours/140° C.)

Chemical resistance: resistance to acid, alkali and amine (change of hardness after 7 days/room temperature)

At the end of the tests, the specimens were measured for physical properties according to JIS K6249. The results of the oil resistance and chemical resistance tests are shown in Tables 1 and 2, respectively.

For comparison purpose, similar tests were carried out on a liquid silicone rubber composition (KE4531G by Shin-Etsu Chemical Co., Ltd.), with the results being also shown in Tables 1 and 2.

### Example 2

A composition was prepared as in Example 1 except that 10 parts of fumed silica (BET specific surface area 180 m²/g) which had been surface treated with hexamethyldi-silazane was used instead of 10 parts of hexamethyltri-silazane-treated fumed silica (BET specific surface area 190 m²/g) in Example 1, and 0.5 part of a tackifier of formula (12) below was added.

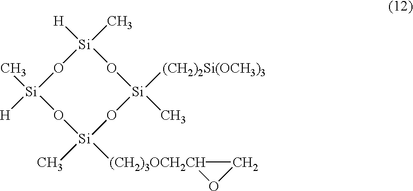

Next, a syringe was filled with the composition. From a nozzle having an inner diameter of 1.2 mm, the composition was extruded onto a polycarbonate resin plate (100×25×2 mm) in bead form. The bead was allowed to stand for one hour, before it was cured by heating in a dryer at 130° C. for one hour. The cured bead had a height (H) and a width (W) in a ratio H/W of 0.95. Also as in Example 1, No. 2 dumbbell specimens similarly prepared were measured for physical properties and subjected to the oil resistance and chemical resistance tests. The results are also shown in Tables 1 and 2.

TABLE 1
Transmission oil resistance
(change of physical properties after 1000 hours/140° C.)

| | Example 1 | | Example 2 | | Comparison | |
|---|---|---|---|---|---|---|
| Properties | Initial | After test | Initial | After test | Initial | After test |
| Hardness | 41 | 45 | 45 | 50 | 40 | 6 |
| Elongation, % | 180 | 160 | 200 | 170 | 370 | 640 |
| Tensile | 2.5 | 2.4 | 2.6 | 2.4 | 3.0 | 0.3 |
| strength, MPa | | | | | | |

TABLE 2
Chemical resistance
(change of hardness after 7 days/room temperature)

| | Example 1 | | Example 2 | | Comparison | |
|---|---|---|---|---|---|---|
| | Hardness | | Hardness | | Hardness | |
| Chemicals | change | Appearance | change | Appearance | change | Appearance |
| HCl (36%) | +3 | no change | +4 | no change | −5 | no change |
| H₂SO₄ | −10 | surface | −13 | surface | un- | dissolved |
| (98%) | | degraded | | degraded | measurable | |
| HNO₃ (60%) | +2 | no change | +3 | no change | −10 | surface |
| | | | | | | degraded |
| NaOH (40%) | 0 | no change | +3 | no change | −9 | surface |
| | | | | | | degraded |
| butylamine | −4 | no change | −5 | no change | un - | dissolved |
| | | | | | measurable | |

Japanese Patent Application No. 2001-142111 is incorporated herein by reference.

Reasonable modifications and variations are possible from the foregoing disclosure without departing from either the spirit or scope of the present invention as defined by the claims.

1. A fluoroelastomer composition for FIPG comprising as essential components,
(A) a fluorinated amide compound having at least two alkenyl radicals in a molecule,
(B) a fluorinated organohydrogensiloxane having at least two hydrogen atoms attached to silicon atoms in a molecule,
(C) a catalytic amount of a platinum group compound, and
(D) a hydrophobic silica powder.

2. The composition of claim 1 further comprising
(E) an organosiloxane having in a molecule at least one hydrogen atom attached to a silicon atom, and at least one epoxy radical attached to a silicon atom through carbon atoms or carbon and oxygen atoms or at least one trialkoxy radical or both.

3. The composition of claim 1 wherein the fluorinated amide compound (A) is of the following general formula (1): 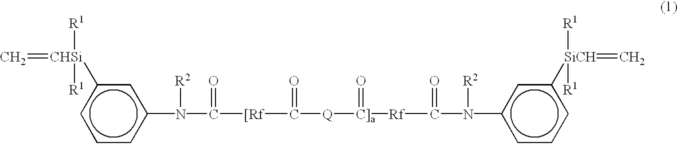
wherein R¹ is a substituted or unsubstituted monovalent hydrocarbon radical,
R² is hydrogen or a substituted or unsubstituted monovalent hydrocarbon radical,
Q is a radical of the following general formula (2) or (3): 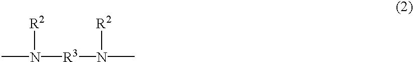
wherein R³ is a substituted or unsubstituted divalent hydrocarbon radical which may be separated by at least one atom of oxygen, nitrogen and silicon atoms, and R² is as defined above, 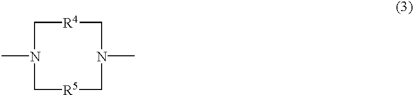
wherein R⁴ and R⁵ each are a substituted or unsubstituted divalent hydrocarbon radical,
Rf is a divalent perfluoroalkylene or perfluoropoly-ether radical, and
“a” is an integer of at least 0.

4. The composition of claim 1 wherein the fluorinated organohydrogensiloxane (B) has at least one monovalent perfluorooxyalkyl, monovalent perfluoroalkyl, divalent perfluorooxyalkylene or divalent perfluoroalkylene radical and at least two hydrogen atoms attached to silicon atoms in a molecule.

5. The composition of claim 1 wherein the hydrophobic silica powder (D) is a silica powder having a BET specific surface area of at least 50 m²/g which has been treated with an organosilane, organosilazane or organopolysiloxane.
